(19) United States
(12) Patent Application Publication
(10) Pub. No.: US 2013/0283365 A1
(43) Pub. Date: Oct. 24, 2013

(54) INTER-AUTONOMOUS SYSTEM WEIGHSTATION

(71) Applicant: Verizon Corporate Services Group Inc., Basking Ridge, NJ (US)

(72) Inventor: Alan Jason Mccabe, Cary, NC (US)

(21) Appl. No.: 13/921,948

(22) Filed: Jun. 19, 2013

Related U.S. Application Data
(63) Continuation of application No. 10/127,728, filed on Apr. 23, 2002, now abandoned.

(51) Int. Cl. H04L 29/06

(52) U.S. Cl. CPC H04L 63/0227
USPC 726/13

(57) ABSTRACT

An approach for providing network security is disclosed. The system includes a first set of routing devices (e.g., routers, routing switches, etc.) operating redundantly within an autonomous system. The system also includes a second set of routing devices that are configured for redundant operation within the autonomous system and to communicate with another autonomous system. The sets of routing devices provide a communication path between the autonomous systems for transport of untrusted packets and trusted packets. Further, the system includes a security node (i.e., weighstation) configured to communicate with the sets of routing devices and to only receive the untrusted packets, wherein the untrusted packets are selectively forwarded to the other autonomous system.

### RELATED APPLICATIONS

The present application is a continuation of U.S. patent application Ser. No. 10/127,728 filed on Apr. 23, 2002, the contents of which are hereby incorporated by reference.

### FIELD OF THE INVENTION

The present invention relates to data communications, and is more particularly related to providing network security for communicating between autonomous systems.

### BACKGROUND OF THE INVENTION

Undoubtedly, the heavy reliance on data networks requires an equal commitment to ensuring that such networks are free from unauthorized access or disruption. Within a single autonomous system, which is managed by a single administrator, security is not usually a grave concern as various management and security controls are in place; however, when this autonomous system communicates with a different autonomous system, particularly an untrusted system (e.g., the Internet), security controls are susceptible to compromise. An autonomous system (AS), which is also referred to as a routing domain, may be defined as a unit of router policy, as either a single network or a group of networks. Given the popularity and ubiquity of the global Internet, private networks are required to interface with this untrusted system, thereby magnifying the concerns over security. Security compromises stemming from viruses or intrusions can cost companies millions of dollars in lost productivity and clean-up.

To mitigate potential security breaches, networks deploy a variety of security measures, notably firewalls at the network boundaries to screen and filter traffic. A firewall, which typically is a conglomeration of hardware and software components, resides at the network perimeter to control access to a private network. When deployed properly, firewalls provide an effective mechanism to block unauthorized users from gaining access to resources of the private network and to control undesired activities by users internal to the private network.

Unfortunately, firewalls have the primary drawback in that they introduce performance degradations. The degradation stems from the fact that each packet flowing into the firewall is screened, thus creating delays in the exchange of packets. Conventional implementations of firewalls follow two architectures. The first approach, which is more popular, largely utilizes diverse paths for untrusted traffic and trusted traffic, as explained below in FIG. 6. The second architecture requires directing all traffic (untrusted and trusted) through the firewall over a single communication path, as described in FIG. 7.

FIG. 6 is a diagram of a conventional arrangement for firewalling between two autonomous systems employing disparate communication paths. A typical corporate network 601 utilizes a firewall 603 to protect against untrusted traffic originating from an untrusted autonomous system (AS) 605, such as the global Internet. The networks within an autonomous system communicate routing information to each other using, for example, an Interior Gateway Protocol (IGP). Further, an autonomous system may share routing information with other autonomous systems using a Border Gateway Protocol (BGP).

As seen in the figure, the untrusted autonomous system 605 interfaces with the corporate network 601 over boundary routers 607, 609, which relay untrusted packets to the firewall 603 along a first communication path 611. The corporate network 601 also employs a second communication path 613 to exchange trusted packets. This trusted communication path 613 is established over boundary routers 615, 617, in which the router 617 is part of a corporate intranet 619 (i.e., a trusted autonomous system). Under this arrangement, two distinct communication paths 611, 613 are required to transport untrusted traffic and trusted traffic, respectively.

One drawback of the above architecture employing separate communication paths is that network resources are used inefficiently, as the use of disparate communication paths require deployment of more equipment. Generally, this approach requires twice the number of networking nodes to implement. As a result, systems utilizing disparate paths entail greater cost to purchase and manage, and are more difficult to perform routing configurations. Therefore, such systems are more prone to configuration errors and system outages.

FIG. 7 is a diagram of a conventional arrangement for firewalling between two autonomous systems over a common communication path. In this scenario, a single communication path 701 carries untrusted and trusted traffic from a corporate network 703 via a corporate intranet 705 to an untrusted AS 707 (e.g., the Internet). To protect against untrusted traffic, the corporate network 703 includes a firewall 709 that filters all traffic exchanged between routers 711, 713, irrespective of whether the traffic includes trusted packets or untrusted packets.

Under this arrangement, the single communication path 701 presents a number of drawbacks. The single path 701 may be a performance bottleneck, as all traffic requires processing through the firewall. Further, if only a single communication path 701 is provided, trusted traffic that traverses this path 701 may be subject to misconfigurations, thereby preventing the flow of traffic known to be harmless. That is, the firewall 709 may introduce errors to packets that are known to be trusted. Because the trusted packets are unnecessarily subjected to the firewall 709, maintenance of the firewall 709, in terms of upgrades and introducing new developments, is not easily executed.

Therefore, there is a need for an approach for providing network security between autonomous systems that minimizes costs, while maximizing security functionalities. There is also a need to minimize degradation in network performance. There is a further need to avoid routing configuration errors. Additionally, there is a need to improve efficient use of network resources and equipment without sacrificing network security.

### SUMMARY OF THE INVENTION

These and other needs are addressed by the present invention in which an approach is provided for securely transporting packets between autonomous systems. A first set of network elements with routing functionality (e.g., routers, routing switches, etc.) are configured to operate redundantly within a first autonomous system. This first set of network elements establishes a communication path with a second set of network elements that also possesses routing functions and is redundantly operative. Within the communication path, a security node is introduced for processing untrusted packets received from the first set of network elements. The untrusted packets are selectively forwarded to the second autonomous system by the security node using one or more security scales (i.e., security policies) in parallel. The above approach advantageously provides ease of security management and configuration. Additionally, the approach minimizes costs and enhances system availability.

In one aspect of the present invention, a method for providing network security between autonomous systems is disclosed. The method includes receiving a packet routed from a network element in communication with one of the autonomous systems, wherein the packet is determined by the network element to be untrusted. The method also includes selectively forwarding the packet to another one of the autonomous systems based on a security policy.

In another aspect of the present invention, a system for providing network security between autonomous systems is disclosed. The system includes a firewall configured to receive a packet forwarded from a routing device in communication with one of the autonomous systems. The packet is determined by the routing device to be untrusted. The firewall is further configured to selectively forward the packet to another one of the autonomous systems.

In another aspect of the present invention, a system for providing network security is disclosed. The system includes a first set of routing devices configured to operate redundantly within an autonomous system. The system also includes a second set of routing devices configured to operate redundantly within the autonomous system and to communicate with another autonomous system, wherein the sets of routing devices provide a communication path between the autonomous systems for transport of untrusted packets and trusted packets. Further, the system includes a security node configured to communicate with the sets of routing devices and to only receive the untrusted packets, wherein the untrusted packets are selectively forwarded to the other autonomous system.

In another aspect of the present invention, a computer-readable medium carrying one or more sequences of one or more instructions for providing network security between autonomous systems is disclosed. The one or more sequences of one or more instructions include instructions which, when executed by one or more processors, cause the one or more processors to perform the step of receiving a packet routed from a network element in communication with one of the autonomous systems, wherein the packet is determined by the network element to be untrusted. Another step includes selectively forwarding the packet to another one of the autonomous systems based on a security policy.

In another aspect of the present invention, a system for providing network security between autonomous systems is disclosed. The system includes means for receiving a packet routed from a network element in communication with one of the autonomous systems, wherein the packet is determined by the network element to be untrusted. The system also includes means for selectively forwarding the packet to another one of the autonomous systems based on a security policy.

In another aspect of the present invention, a method for securely transporting packets is disclosed. The method includes determining whether a packet received from a host within a first autonomous system is untrusted based on a routing criterion. The method also includes routing the packet over a communication path to a second autonomous system, if the packet is not untrusted. Further, the method includes routing the packet over the communication path to a security node, if the packet is untrusted, wherein the security node selectively forwards the packet to the second autonomous system based on at least one of a plurality of security policies.

In another aspect of the present invention, a computer-readable medium carrying one or more sequences of one or more instructions for securely transporting packets is disclosed. The one or more sequences of one or more instructions include instructions which, when executed by one or more processors, cause the one or more processors to perform the step of determining whether a packet received from a host within a first autonomous system is untrusted based on a routing criterion. Another step includes routing the packet over a communication path to a second autonomous system, if the packet is not untrusted. Yet another step includes routing the packet over the communication path to a security node, if the packet is untrusted, wherein the security node selectively forwards the packet to the second autonomous system based on at least one of a plurality of security policies.

In yet another aspect of the present invention, a network apparatus for providing network security between autonomous systems is disclosed. The apparatus includes a routing device configured to screen a packet from one of the autonomous systems, wherein the packet is determined by the routing device to be untrusted. The apparatus also includes a firewall configured to receive the packet forwarded from the routing device in communication, and to selectively forward the packet to another one of the autonomous systems.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various obvious respects, all without departing from the spirit and scope of the present invention. Accordingly, the drawing and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram of a communications system utilizing a weighstation to provide network security over a common communication path between autonomous systems, according to an embodiment of the present invention;

FIG. 2 is a diagram of a weighstation supporting multiple security scales, according to an embodiment of the present invention;

FIG. 3 is a flow chart of the operation of the weighstation of FIG. 1;

FIG. 4 is a diagram showing connectivity of two autonomous systems via redundantly configured routing devices, whereby a weighstation is utilized to provide network security, according to an embodiment of the present invention;

FIG. 5 is a diagram of a computer system that can be used to implement an embodiment of the present invention;

FIG. 6 is a diagram of a conventional arrangement for firewalling between two autonomous systems over disparate communication paths; and

FIG. 7 is a diagram of a conventional arrangement for firewalling between two autonomous systems over a common communication path.

### DESCRIPTION OF THE PREFERRED EMBODIMENT

A system, method, and software for securely transporting packets between autonomous systems are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

Although the present invention is explained with respect to packet-switched networks, the present invention also has applicability to data networks in general (e.g., frame relay networks, Asynchronous Transfer Mode (ATM) networks, etc.).

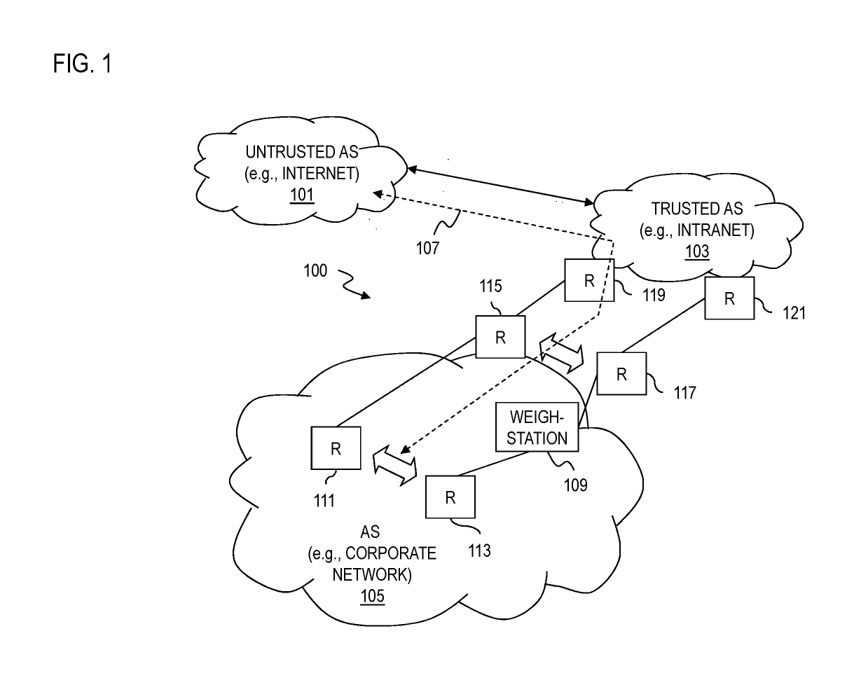

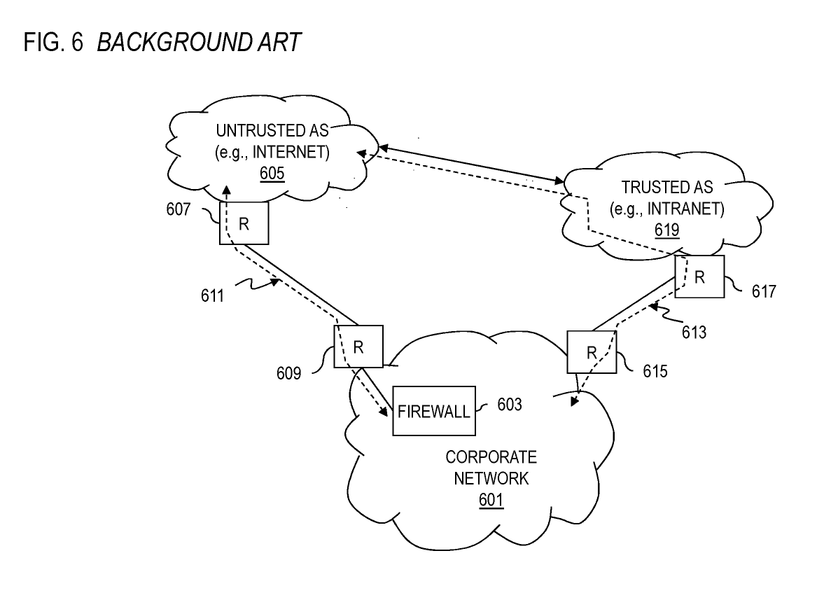

FIG. 1 is a diagram of a communications system utilizing a weighstation to provide network security over a common communication path between autonomous systems, according to an embodiment of the present invention. A communications system 100 includes interlinked autonomous systems (AS) 101, 103, 105. In this example, the AS 101 is an untrusted system, such as the global Internet, while the AS 103 represents a trusted system (e.g., a corporate intranet). The AS 105 may represent a corporate network 105, which communicates with the trusted AS 103 and untrusted AS 101 through a single communication path with the trusted AS 103. Unlike the conventional approach of FIG. 6, the single communication path 107 commonly transports both untrusted and trusted traffic between the AS 105 and the AS 103.

According to an embodiment of the present invention, the communication path 107 is implemented as a redundant routing path 107 in which a security node (“weighstation”) 109 is introduced along one of the redundant legs of the communication path 107. In an exemplary embodiment, the weighstation 109 distinguishes untrusted traffic from trusted traffic and monitors untrusted traffic for anomalies for traffic originating and terminating within the AS 105. The traffic anomalies may include traffic attacks, intrusion detection, firewall criteria filtering and traffic signatures. In general, the screening techniques are performed based on route information, or path information in conformance with a security policy. Examples of screening techniques include, for example, examining packets to determine whether the packets originate from an acceptable domain name and/or Internet Protocol (IP) address, filtering packets based on the ports from which packets are received or transmitted to, the type of packet or datagram received, etc.

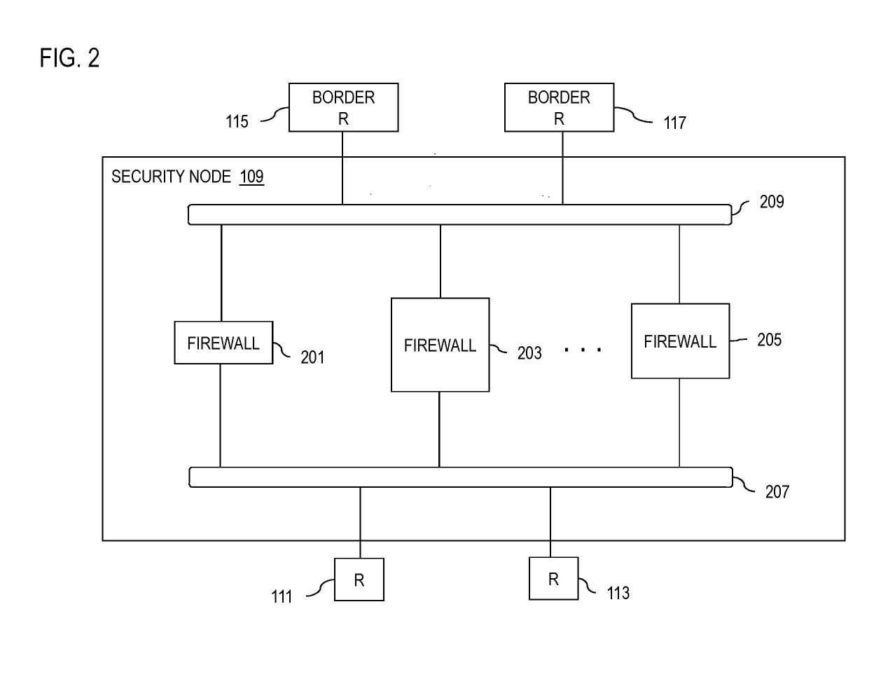

The weighstation 109 uses, in an exemplary embodiment, parallel network elements 111, 113, 115, 117 with routing capabilities (i.e., routing devices) at each hop, with parallel paths between hops, and parallel high-availability (HA) firewalls to provide physical path redundancy between two autonomous systems 103, 105. The network elements 111, 113, 115, 117 include any device that is capable of performing network routing, such as routers, switching hubs, etc. This parallel architecture is described with respect to FIG. 2. In an alternative embodiment, the determination of whether the traffic is trusted or untrusted can be performed by the network elements 111, 113, 115, 117 which can employ a combination of standard routing and Policy-Based Routing (PBR) to distinguish and direct qualifying traffic, such that only untrusted traffic is forwarded to the weighstation 109. It is noted that, however, any criterion selection capability may be used to distinguish trusted traffic from untrusted traffic.

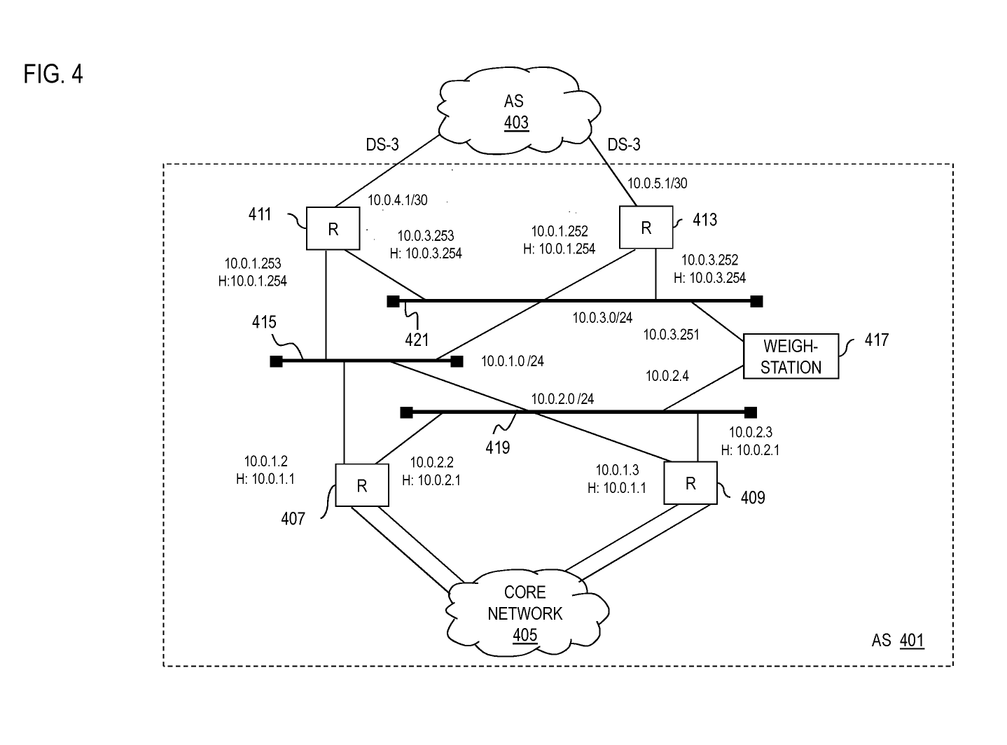

In accordance with one embodiment of the present invention, the network elements 111, 113 are routing switches with multi-VLAN interfaces, while the network elements 115, 117 are routers. The routing switches 111, 113 are interconnected via an inner firewall segment according to the Internet Engineering Task Force (IETF) Virtual Router Redundancy Protocol (VRRP). An outer firewall segment connects the routers 115, 117, which are similarly configured for redundancy via the VRRP. The routers 115, 117, in an exemplary embodiment, are boundary routers that communicate with boundary routers 119, 121 of the trusted AS 103. According to one embodiment of the present invention, parallel LAN switches with multi-VLAN support are deployed in the corporate network 105 to provide parallel traffic transit subnets between hops; this architecture is more fully described with respect to FIG. 4.

As described above, virtual network interface redundancy, in an exemplary embodiment, may be performed according to the VRRP, which supports redundantly configured routing devices by enabling the use of one or more backup routers (when using a statically configured router on a LAN). With VRRP, a virtual IP address, which may be, for example, specified manually or with Dynamic Host Configuration Protocol (DHCP), is shared among the routing devices so as the redundant devices appear as a single network element. One of the routing devices is designated as a master, and one or more other routing devices are specified as backups. In the event that the master router fails, the virtual IP address is mapped to one of the backup router's IP address, thereby assuming the master role. In addition to supporting redundant operation of routing devices, the VRRP may be used for load balancing. VRRP is more detailed in IETF Request For Comment (RFC) 2338, which is incorporated herein by reference in its entirety.

Alternatively, for routing devices that support operating systems by CISCO SYSTEMS, the Hot Standby Routing Protocol (HSRP) may be utilized. HSRP defines a mechanism for determining which device is active and standby through the use of the IP addresses of such devices. Notably, HSRP ensures that only a single router (i.e., “active” router) operates at any particular time to forwarding packets on behalf of the “virtual” router. A standby router pre-designated to assume the role of active router, upon failure of the current active router. On any given LAN, multiple hot standby groups (possibly overlapping) may exist. Details of the HSRP are disclosed in IETF RFC 2281, which is incorporated herein by reference in its entirety.

The weighstation 109 may employ one or more firewalls in parallel to effect the security policies of the corporate network 105. A firewall, in general terms, protects the resources of the corporate network 105 from access by unauthorized users by screening traffic from an untrusted source, such as the Internet 101. In this example, the weighstation 109 operates in conjunction with the redundantly configured routing devices 111, 113 to detect and filter untrusted traffic, using any number of screening techniques, as described previously. For instance, to the weighstation 109 can examine the received packets to determine whether they originate from a known domain name and/or IP addresses. Additionally, the firewall functionalities of the weighstation 109 may include logging and reporting as well as alarm generation.

Thus, the weighstation 109 provides a mechanism to differentiate trusted network traffic from untrusted network traffic and to monitor untrusted traffic along the common routing path 107 for components outside of the weighstation's “on/off ramps.” As shown, this mechanism is deployed at inter-AS access boundaries to provide advanced security capability at these boundaries. The weighstation 109 off-loads that untrusted traffic to an HA firewalled path of the weighstation 109 for firewall filtering, intrusion detection, and a variety of traffic monitoring techniques. Untrusted traffic is distinguished at each inter-AS periphery and directed to the weighstation 109 off-ramp for analysis by the HA firewall and intermediate monitors. After inspection, the HA firewalls direct the untrusted traffic onto the on-ramp and back into the inbound-AS traffic flow. Trusted traffic is distinguished at each inter-AS periphery. This architecture differs from that of the single path architecture of FIG. 6 in part because of the capability to direct traffic flow, as more fully described below. Further, a number of conventional approaches (shown in FIG. 6) implement completely diverse paths for the two traffic types, thereby requiring an increased number of nodes (i.e., twice the number of networking nodes).

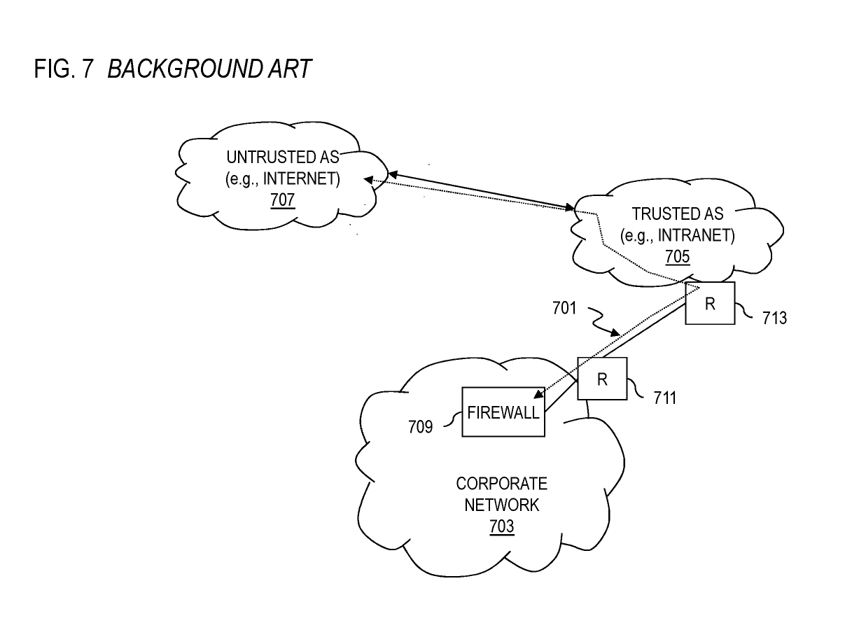

Because the above weighstation architecture provides for a common routing path outside of the scope of the weighstation/firewall on/off ramps, the total cost of ownership is minimized, particularly compared with the conventional approach of using completely disparate paths. The above approach also lessens the number of nodes required for similar, but diverse, implementations. If firewalls or other filtering/monitoring nodes are placed in a single path, under the conventional approach (as described in FIG. 7), trusted traffic is subject to the impact of those nodes in the path; however, under the arrangement of FIG. 1, only untrusted traffic is screened, thereby minimizing network performance degradation and eliminating the possibility of introducing errors with respect to trusted traffic.

FIG. 2 is a diagram of a weighstation supporting multiple scales, according to an embodiment of the present invention. The weighstation (i.e., security node) 109 of FIG. 1 can employ one or more firewalls 201, 203, 205 to apply a variety of security policies on untrusted packets exchanged between autonomous systems. As seen, the firewalls 201, 203, 205 are connected in parallel by two local area network (LAN) segments 207, 209. An inner firewall segment 207, as previously mentioned, provides connectivity for the routers 111, 113, while an outer firewall segment 209 connects the boundary routers 115, 117.

The weighstation 109, in an exemplary embodiment, can provide sophisticated firewalling features, such as session direction and stateful-inspection. The security features of the firewalls 201, 203, 205 can provide network protection at various levels. One or more of these firewalls 201, 203, 205 can specify the types of applications that are permitted, but otherwise restrict access to the network (e.g., network 105); for example, e-mail, file transfer (e.g., File Transfer Protocol) and remote login may be allowed, while limiting access to the internal network (e.g., corporate network 105). Also, the firewalls 201, 203, 205 can provide an authorization mechanism such that only specified users or applications can gain access through the firewall. As indicated, logging and alerting feature can be supported by the firewalls 201, 203, 205 to track designated usage and trigger signals based on specified events. These firewalls 201, 203, 205 can also perform network address translation to mask the actual name and address of hosts communicating through the firewalls 201, 203, 205. In an exemplary embodiment, the firewalls 201, 203, 205 can be implemented as CHECKPOINT FW-1 HA firewalls, RADWARE FireProof traffic directors, or a combination thereof.

Under this arrangement, the weighstation 109 advantageously permits implementation of numerous security products in the topology. Further, the weighstation 109 can selectively apply one or more firewalls 201, 203, 205 to the untrusted traffic forwarded from the routers 111, 113. In general, untrusted traffic can be distinguished into N parts with N on/off-ramps (or ingress and egress routes to the weighstation 109)—i.e., “parallel scales.” Therefore, the modularity of the firewalls thus provides the flexibility to tailor the screening of the packets based on certain characteristics and to apply different security treatments.

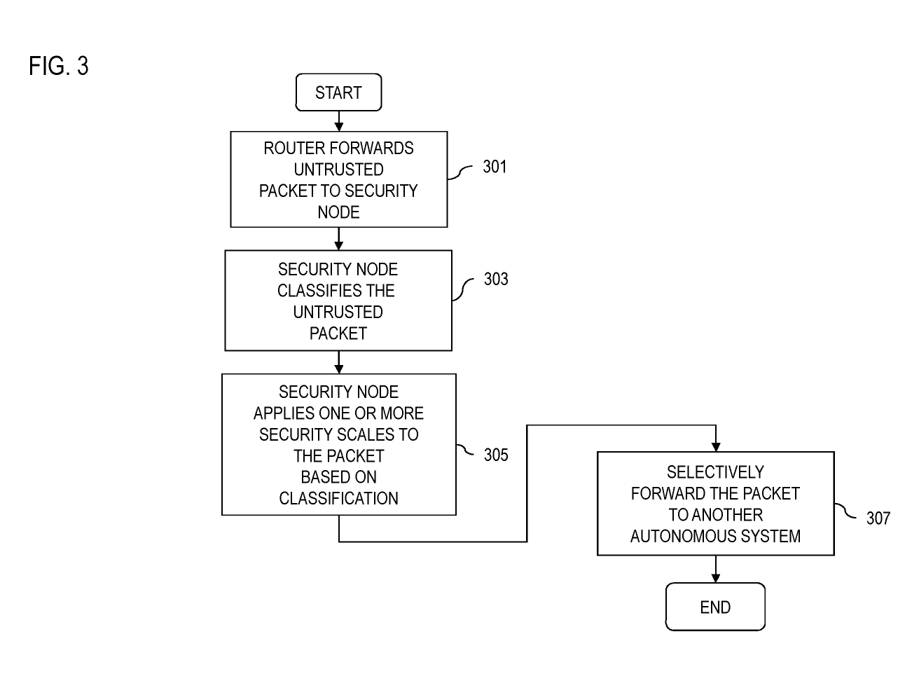

FIG. 3 is a flow chart of the operation of the weighstation of FIG. 1. Within the corporate network 105, a number of hosts (not shown) generate and transport packets, which are trusted and untrusted. These packets reach the virtual router that is implemented by redundantly configured routers 111, 113. Assuming that the router 111 is the primary router, the router 111 examines the packet to determine whether the packets are untrusted or untrusted, per step 301, based on one or more routing criteria, and forwards untrusted packets to the security node 109. In turn, the security node can classify the received untrusted packets, as in step 303, to determine the particular security policy (i.e., security scale) to apply. In step 305, the security node 109 applies the appropriate security scale (or multiple security scales) according to the classification. Thereafter, the security node 109 forwards the screened packets, as in step 307, to the AS 103 and the AS 101. It is observed that the communication path 107 represents bi-directional communication.

FIG. 4 is a diagram showing connectivity of two autonomous systems via redundantly configured routing devices, whereby a weighstation is utilized to provide network security, according to an embodiment of the present invention. For the purposes of explanation, the operation of a weighstation, according to one embodiment of the present invention, is described in the context of two autonomous systems 401, 403. The AS 401 includes a core network 405 connected to redundantly configured interior routers 407, 409, which along with boundary routers 411, 413 form parallel paths to the AS 403. According to one embodiment of the present invention, the interior routers 407, 409 are routing switches. In this example, one of the parallel paths is established over a direct transfer segment 415 that bypasses a weighstation 417. The interior routers 407, 409 also connect to an inner firewall segment 419. The boundary routers 411, 413 possess interfaces to the direct transfer segment 415 as well as an outer firewall segment 421.

Given the topology of the AS 401, trusted traffic can take one of two parallel paths from the AS 401. The first path is from the routing switch 407 to the router 411 through the direct transfer segment 119, and off to the other autonomous system 403 via, for example, a WAN link (e.g., DS3). As shown, the weighstation 417 does not reside exactly between AS boundaries 401, 403, but in fact is inside the AS 401. The routers 411, 413, the weighstation 417, and the routing switches 407, 409 are part of the same “inside” AS 401. The second trusted path is from the routing switch 409, to the direct transfer segment 415, to the router 413, and off to the AS 403 via an alternate WAN link (e.g., DS3). The direct transfer segment 415, in an exemplary embodiment, has representation in parallel VLAN switches (not shown), as do the other segments 419, 421.

For untrusted traffic, packets flow from the router 407 to the weighstation 417 via the inner firewall segment 419, and then to the router 411 via the outer firewall segment 421. The alternate path is through the routing switch 409, the weighstation 417, and the router 413.

In this example, the selection of one path over the other in either the trusted or untrusted scenario is based on VRRP interface weight. These weights can be configured by network administrators for control over traffic flow to implement load-balancing and other sophisticated traffic shaping techniques. In addition, routing protocols such as multi-path Open Shortest Path First (OSPF) and Interior/Exterior Border Gateway Protocol (i/eBGP) can be utilized across the entire topology for more sophisticated flow objectives.

Under this arrangement, normal routing parameters are used by the routers 407, 409 to direct applicable trusted traffic via the direct path over the direct transfer segment 415. For example, it is assumed that trusted destinations correspond to an IP address block of 10.0.6.0 /24. Further, it is assumed that HSRP is utilized, static routes can be configured to target out toward the HSRP interface(s) of the routers 411, 413 on the direct transfer segment 415 from the interior routers 407, 409, via the following command:
ip route 10.0.6.0 255.255.255.0 10.0.1.254.

Additionally, it is assumed that Internet traffic is untrusted; that is, traffic destined for the AS 101. This untrusted traffic is routed toward the HA firewalls of the weighstation 103, according to the following command:
ip route 0.0.0.0 0.0.0.0 10.0.2.4.

According to one embodiment of the present invention, target IP address blocks are used as the routing criterion for the routers 407, 409; however, it is noted that other criteria can be employed. For example, any directable routing criterion may be supported to make such distinctions.

For outside traffic going in, policy-based routing can be utilized in routers 411 and 413 to make the distinction based on traffic source, according to the following script:

```
interface Serial2/0
  description interface WAN DS3
  ip policy route-map direct
route-map direct permit 70
  match ip address 175
  set ip next-hop 10.0.1. 1 [symbol]
access-list 175 permit ip [symbol]   any
```

As stated, all other traffic is assumed to be untrusted, and therefore handled by standard routing for the address blocks within the core network 405. For example, assume that the IP address block representing the core network 405 is 10.0.7.0 /24. The routing command to effect this in routers 411 and 413 is as follows:
ip route 10.0.7.0 255.255.255.0 10.0.3.251

It is noted that routing criteria, under this arrangement, are added in pairs, in which there is one set of configuration for the in-out flow and a matching set for the out-in flow.

The above arrangement advantageously avoids unnecessarily deploying expensive networking equipment by permitting use of a single communication path without incurring the network performance compromise associated with a traditional single path design. Notably, the fact that the communication path can off load untrusted traffic to a security node minimizes performance degradation, as trusted traffic is directly routed. Further, the modularity of the weighstation 417 provides great flexibility in implementing security features.

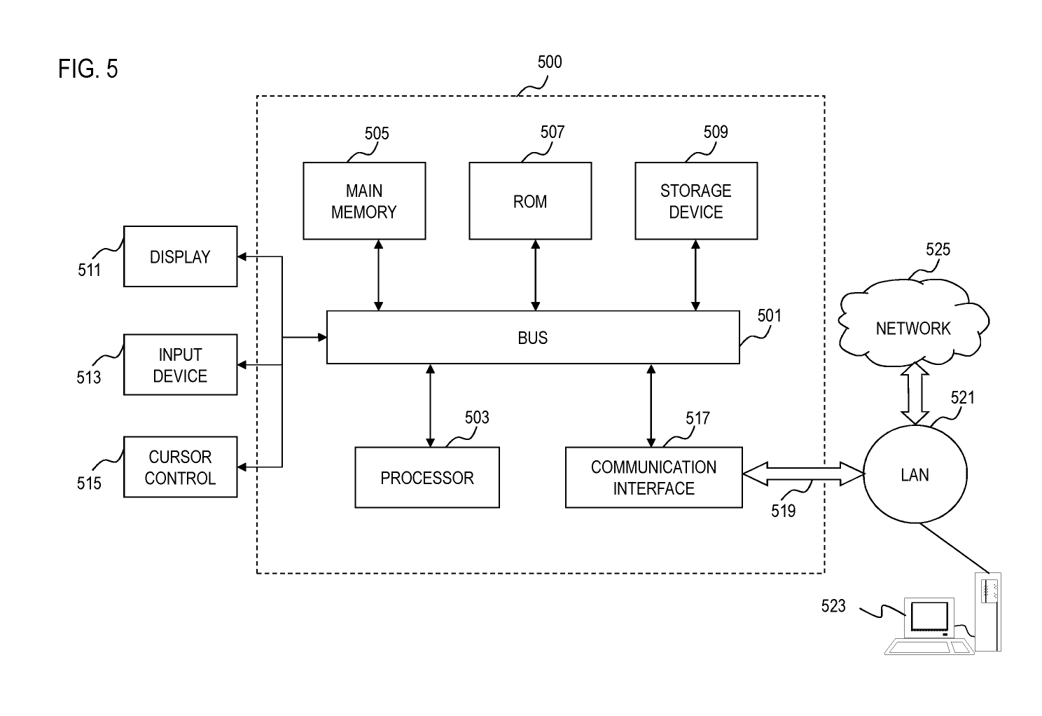

FIG. 5 illustrates a computer system 500 upon which an embodiment according to the present invention can be implemented. The computer system 500 includes a bus 501 or other communication mechanism for communicating information and a processor 503 coupled to the bus 501 for processing information. The computer system 500 also includes main memory 505, such as a random access memory (RAM) or other dynamic storage device, coupled to the bus 501 for storing information and instructions to be executed by the processor 503. Main memory 505 can also be used for storing temporary variables or other intermediate information during execution of instructions by the processor 503. The computer system 500 may further include a read only memory (ROM) 507 or other static storage device coupled to the bus 501 for storing static information and instructions for the processor 503. A storage device 509, such as a magnetic disk or optical disk, is coupled to the bus 501 for persistently storing information and instructions.

The computer system 500 may be coupled via the bus 501 to a display 511, such as a cathode ray tube (CRT), liquid crystal display, active matrix display, or plasma display, for displaying information to a computer user. An input device 513, such as a keyboard including alphanumeric and other keys, is coupled to the bus 501 for communicating information and command selections to the processor 503. Another type of user input device is a cursor control 515, such as a mouse, a trackball, or cursor direction keys, for communicating direction information and command selections to the processor 503 and for controlling cursor movement on the display 511.

According to one embodiment of the invention, the process of FIG. 3 is provided by the computer system 500 in response to the processor 503 executing an arrangement of instructions contained in main memory 505. Such instructions can be read into main memory 505 from another computer-readable medium, such as the storage device 509. Execution of the arrangement of instructions contained in main memory 505 causes the processor 503 to perform the process steps described herein. One or more processors in a multi-processing arrangement may also be employed to execute the instructions contained in main memory 505. In alternative embodiments, hard-wired circuitry may be used in place of or in combination with software instructions to implement the embodiment of the present invention. Thus, embodiments of the present invention are not limited to any specific combination of hardware circuitry and software.

The computer system 500 also includes a communication interface 517 coupled to bus 501. The communication interface 517 provides a two-way data communication coupling to a network link 519 connected to a local network 521. For example, the communication interface 517 may be a digital subscriber line (DSL) card or modem, an integrated services digital network (ISDN) card, a cable modem, a telephone modem, or any other communication interface to provide a data communication connection to a corresponding type of communication line. As another example, communication interface 517 may be a local area network (LAN) card (e.g. for Ethernet™ or an Asynchronous Transfer Model (ATM) network) to provide a data communication connection to a compatible LAN. Wireless links can also be implemented. In any such implementation, communication interface 517 sends and receives electrical, electromagnetic, or optical signals that carry digital data streams representing various types of information. Further, the communication interface 517 can include peripheral interface devices, such as a Universal Serial Bus (USB) interface, a PCMCIA (Personal Computer Memory Card International Association) interface, etc. Although a single communication interface 517 is depicted in FIG. 5, multiple communication interfaces can also be employed.

The network link 519 typically provides data communication through one or more networks to other data devices. For example, the network link 519 may provide a connection through local network 521 to a host computer 523, which has connectivity to a network 525 (e.g. a wide area network (WAN) or the global packet data communication network now commonly referred to as the “Internet”) or to data equipment operated by a service provider. The local network 521 and network 525 both use electrical, electromagnetic, or optical signals to convey information and instructions. The signals through the various networks and the signals on network link 519 and through communication interface 517, which communicate digital data with computer system 500, are exemplary forms of carrier waves bearing the information and instructions.

The computer system 500 can send messages and receive data, including program code, through the network(s), network link 519, and communication interface 517. In the Internet example, a server (not shown) might transmit requested code belonging an application program for implementing an embodiment of the present invention through the network 525, local network 521 and communication interface 517. The processor 503 may execute the transmitted code while being received and/or store the code in storage device 59, or other non-volatile storage for later execution. In this manner, computer system 500 may obtain application code in the form of a carrier wave.

The term “computer-readable medium” as used herein refers to any medium that participates in providing instructions to the processor 505 for execution. Such a medium may take many forms, including but not limited to non-volatile media, volatile media, and transmission media. Non-volatile media include, for example, optical or magnetic disks, such as storage device 509. Volatile media include dynamic memory, such as main memory 505. Transmission media include coaxial cables, copper wire and fiber optics, including the wires that comprise bus 501. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

Accordingly, the present invention provides an approach for securely transporting packets between autonomous systems. A first set of network elements with routing functionality (e.g., routers, routing switches, etc.) are configured to operate redundantly within a first autonomous system. These first set of network elements establishes a communication path with a second set of network elements that also possesses routing functions and are redundantly operative. Within the communication path, a security node is introduced for processing untrusted packets received from the first set of network elements. The untrusted packets are selectively forwarded to the second autonomous system by the security node using one or more security scales (i.e., security policies) in parallel. The above approach advantageously provides ease of security management and configuration. Additionally, the approach minimizes costs and enhances system availability.

While the present invention has been described in connection with a number of embodiments and implementations, the present invention is not so limited but covers various obvious modifications and equivalent arrangements, which fall within the purview of the appended claims.

1. (canceled)

2. A method comprising:
establishing a plurality of routing legs of a common communication path for transport of a traffic flow from a trusted autonomous system to a private autonomous system, wherein the routing legs are redundant;
receiving, via a weighstation deployed at one of the redundant routing legs, untrusted traffic from the traffic flow;
off-loading the untrusted traffic, by the weighstation, to a firewalled path of the weighstation for analysis; and
selectively bypassing the weighstation for trusted traffic from the traffic flow.

3. A method according to claim 2, wherein the communication path further interlinks an untrusted autonomous system, the trusted autonomous system, and the private autonomous system using the common communication path.

4. A method according to claim 2, further comprising:
distinguishing, at the weighstation, the untrusted traffic according to a plurality of classifications corresponding to a plurality of security treatments; and
applying, via the weighstation, a particular one of the plurality of security treatments to the untrusted packets according to the corresponding one of the plurality of classifications.

5. A method according to claim 4, wherein the weighstation is deployed at the private autonomous system, and the weighstation includes a plurality of firewalls that are connected in parallel.

6. A method according to claim 5, wherein the weighstation is connected to an inner firewall segment and an outer firewall segment, and the untrusted traffic flows to the weighstation via the inner firewall segment and to a boundary router via the outer firewall segment.

7. An apparatus comprising:
at least one processor; and
at least one memory including computer program code for one or more programs,
the at least one memory and the computer program code configured to, with the at least one processor, cause the apparatus to perform at least the following,
establish a plurality of routing legs of a common communication path for transport of a traffic flow from a trusted autonomous system to a private autonomous system, wherein the routing legs are redundant,
receive, via a weighstation deployed at one of the redundant routing legs, untrusted traffic from the traffic flow,
off-load the untrusted traffic, by the weighstation, to a firewalled path of the weighstation for analysis, and
selectively bypass the weighstation for trusted traffic from the traffic flow.

8. An apparatus according to claim 7, wherein the communication path further interlinks an untrusted autonomous system, the trusted autonomous system, and the private autonomous system using the common communication path.

9. An apparatus according to claim 7, wherein the apparatus is further caused to:
distinguish, at the weighstation, the untrusted traffic according to a plurality of classifications corresponding to a plurality of security treatments; and
apply, via the weighstation, a particular one of the plurality of security treatments to the untrusted packets according to the corresponding one of the plurality of classifications.

10. An apparatus according to claim 9, wherein the weighstation is deployed at the private autonomous system, and the weighstation includes a plurality of firewalls that are connected in parallel.

11. An apparatus according to claim 10, wherein the weighstation is connected to an inner firewall segment and an outer firewall segment, and the untrusted traffic flows to the weighstation via the inner firewall segment and to a boundary router via the outer firewall segment.

12. A system comprising:
a weighstation configured to receive untrusted traffic of a traffic flow from a trusted autonomous system over a common communication path;
a set of boundary routers coupled to the trusted autonomous system;
a set of interior routers coupled to the respective boundary routers, the interior routers and the boundary routers being part of the common communication path;
a inner firewall segment formed between the interior routers and the weighstation, the inner firewall segment being configured to carry the untrusted traffic; and
an outer firewall segment formed between the boundary routers and the weighstation, the outer firewall segment being configured to carry the untrusted traffic,
wherein the untrusted traffic is off-loaded to the weighstation for analysis, and trusted traffic is transported via the interior routers and the boundary routers to bypass the weighstation.

13. A system according to claim 12, wherein the communication path further interlinks an untrusted autonomous system and the trusted autonomous system.

14. A system according to claim 12, wherein the weighstation is configured to distinguish the untrusted traffic according to a plurality of classifications corresponding to a plurality of security treatments, the weighstation applying a particular one of the plurality of security treatments to the untrusted packets according to the corresponding one of the plurality of classifications.

15. A system according to claim 14, wherein the weighstation includes a plurality of firewalls that are connected in parallel.

16. A system according to claim 15, wherein the boundary routers are coupled to a private autonomous system.

17. A system according to claim 15, wherein the interior routers are routing switches.

18. A system according to claim 15, wherein routing criteria for the untrusted traffic are specified in pairs that include an in-out flow configuration and an out-in flow configuration, the routing criteria being used by any one of the boundary routers.

19. A system according to claim 15, wherein a range of network addresses are designated for use as routing criterion for the interior routers.

20. A system according to claim 15, wherein the untrusted traffic is distinguished into a plurality of N parts with N ingress and egress routes to the weighstation, N being an integer.

21. A system according to claim 15, wherein one of the set of interior routers is designated as a primary interior router, and one of the set of boundary routers is designated as a primary boundary router.
